(19) United States
(12) Patent Application Publication
(10) Pub. No.: US 2006/0182446 A1
(43) Pub. Date: Aug. 17, 2006

(54) Integrated wired and wireless WDM PON apparatus using mode-locked light source

(75) Inventors: Yong-Gyoo Kim, Seoul (KR); Kwan-Soo Lee, Seoul (KR); Chang-Sup Shim, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/357,640

(22) Filed: Feb. 17, 2006

(30) Foreign Application Priority Data
Feb. 17, 2005 (KR) 2005-13259

(51) Int. Cl. H04J 14/00

(52) U.S. Cl. 398/72

(57) ABSTRACT

Integrated wired and wireless wavelength division multiplexing passive optical network (WDM PON) apparatus using a light source mode-locked to fed incoherent light includes: a fed light generator for providing fed light for up/downstream signals via a broadband light source emitting an incoherent optical signal; a central office (CO) for receiving, mode-locking, and downstream-optical-transmitting the incoherent optical signal generated by the fed light generator and receiving and optical-detecting an upstream optical signal transmitted from a subscriber unit; and the subscriber unit for receiving, mode-locking, and upstream-optical-transmitting the incoherent optical signal generated by the fed light generator and receiving and optical-detecting a downstream optical signal transmitted from the CO, wherein a wired optical transmitter for transmitting a baseband wired signal and a wireless optical transmitter for transmitting a high frequency radio frequency (RF) signal are comprised for up/downstream optical transmission of the CO and the subscriber unit.

### CLAIM OF PRIORITY

This application claims priority under 35 U.S.C. §119 to an application entitled “Integrated Wired and Wireless WDM PON Apparatus Using Mode-Locked Light Source,” filed in the Korean Intellectual Property Office on Feb. 17, 2005 and assigned Serial No. 2005-13259, the contents of which are incorporated herein by reference.

### BACKGROUND OF THE INVENTION

1. Field of the Invention

The present invention relates generally to a wavelength division multiplexing passive optical network (WDM PON), and in particular, to a WDM PON using fed light, with which a broadband wireless communication network is combined.

2. Description of the Related Art

Optical communication technology such as WDM or optical time division multiplexing (OTDM) and wireless communication technology such as code division multiple access (CDMA) have been independently developed for use in a broadband communication network.

FIG. 1 is a block diagram of a WDM PON using a mode-locked light source according to the prior art.

As illustrated in FIG. 1, the conventional WDM PON consists of a downlink structure using a mode-locked light source including a broadband light source (BLS) 101 outputting an incoherent optical signal used as fed light, an optical path module 102 setting paths of the incoherent optical signal input from the BLS 101 and up/downstream optical signals. In addition the conventional WDM PON further consists of a first arrayed waveguide (AWG) 103 demultiplexing the incoherent optical signal input through the optical path module 102 and multiplexing optical modulation signals input from a plurality of optical transmitters 104-1 to 104-n. The plurality of optical transmitters 104-1 to 104-n, each receiving the incoherent optical signal demultiplexed by the first AWG 103 and optical-modulating the demultiplexed incoherent optical signal so as to carry data for downstream transmission. A second AWG 105 demultiplexing the multiplexed downstream optical signal received from the first AWG 103 in a wavelength basis, and optical receivers 106-1 to 106-m in the subscriber side for optical-detecting the downstream optical signal demultiplexed by the second AWG 105.

The optical transmitters 104-1 to 104-n may use a mode-locked Fabry-Perot laser diode (FP-LD) or a reflective semiconductor optical amplifier (R-SOA).

FIG. 2 is a block diagram of an Radio-over-Fiber (RoF) link for transmitting a radio frequency (RF) signal according to the prior art.

As illustrated in FIG. 2, the conventional Radio-over-Fiber (RoF) link for transmitting an RF signal which is based on the technology for transmitting an RF signal using optical fiber, in which modulation data is generated by a central office (CO) 21, optical-transmitted to a remote antenna unit 22, and radio-transmitted by the remote antenna unit 22.

The CO 21 includes an RF oscillator 202 generating a frequency signal for frequency modulation, a modulator 201 for RF-modulation of the input data using the RF oscillator 202, and an electro-optic (E/O) converter 203 for optical modulation of the RF-modulated data.

The remote antenna unit 22, includes an optic-electro (O/E) converter 204 for O/E-converting an optical signal transmitted from the CO 21 and an antenna 204 for radio-transmitting the O/E-converted RF modulation signal.

In the conventional art, in order to optical-transmit a high frequency RF signal which is RF-modulated in the RoF link, linearity of the E/O converter 203 must be excellent, and in addition the modulation bandwidth thereof must be wide. In order to provide for linearity and wide modulation bandwidth the conventional E/O converter 203 of the RoF link uses an expensive analog distribute feedback (DFB) laser, or an external optical modulator is used as the E/O converter 203.

When the optical network illustrated in FIG. 1 and the RoF link illustrated in FIG. 2 are used as a wired network and a wireless network, respectively, it is difficult to effectively manage the networks since connection between them using optical fiber is necessary. In addition, when the optical network illustrated in FIG. 1 and the RoF link illustrated in FIG. 2 are combined, the RoF link is applied to the existing WDM PON. In that case, the mode-locked FP-LD or the R-SOA cannot be used as a high frequency E/O converter since it has too narrow a modulation bandwidth.

Therefore, in order to link an existing WDM PON with a RoF link without changing the structure of an existing WDM PON, there is a need for an optical transmitter having a wide modulation bandwidth in E/O conversion for optical transmission.

### SUMMARY OF THE INVENTION

Therefore, the present invention has been made to reduce costs and overcome the limitations of the prior art. It is one aspect of the present invention to provide an integrated wired and wireless WDM PON apparatus for achieving efficient wired and wireless integration by linking a wireless network based on an RoF link to a WDM PON using an FP electro-absorption modulated laser (FP-EML) having a wide modulation bandwidth.

According to one aspect of the present invention, there is provided an integrated wired and wireless wavelength division multiplexing passive optical network (WDM PON) apparatus using a light source mode-locked to fed incoherent light. The integrated wired and wireless WDM PON apparatus comprises: a fed light generator for providing fed light for up/downstream signals by comprising a broadband light source emitting an incoherent optical signal; a central office (CO) for receiving, mode-locking, and downstream-optical-transmitting the incoherent optical signal generated by the fed light generator and receiving and optical-detecting an upstream optical signal transmitted from a subscriber unit; and a subscriber unit for receiving, mode-locking, and upstream-optical-transmitting the incoherent optical signal generated by the fed light generator and receiving and optical-detecting a downstream optical signal transmitted from the CO, wherein a wired optical transmitter for transmitting a baseband wired signal and a wireless optical transmitter for transmitting a high frequency radio frequency (RF) signal are configured for up/downstream optical transmission of the CO and the subscriber unit.

According to one embodiment of the present invention, there is provided a structure for downstream optical transmission in an integrated wired and wireless wavelength division multiplexing passive optical network (WDM PON) apparatus using a light source mode-locked to fed incoherent light. The integrated wired and wireless WDM PON apparatus comprises: a broadband light source (BLS) for outputting an incoherent optical signal used as fed light; an optical path module for setting paths of the incoherent optical signal input from the BLS and up/downstream optical signals; a first arrayed waveguide (AWG) for demultiplexing the incoherent optical signal input through the optical path module and transmitting the demultiplexed incoherent optical signals to a plurality of wired/wireless optical transmitters, and multiplexing optical modulation signals received from the plurality of wired/wireless optical transmitters.

The plurality of wired optical transmitters each receive the demultiplexed incoherent optical signal from the first AWG, mode-lock the demultiplexed incoherent optical signal for downstream transmission, and optical-modulate the mode-locked incoherent optical signal to carry baseband wired signal data. The plurality of wireless optical transmitters, each receive, and mode-lock and like their wired counterpart, however they optical-modulate the mode-locked incoherent optical signal to carry high frequency radio frequency (RF) signal data.

The integrated wired and wireless WDM PON apparatus in this embodiment further comprises: a second AWG for demultiplexing the multiplexed downstream optical signal received from the first AWG in a wavelength basis; and optical receivers for subscribers and for optical-detecting the demultiplexed downstream optical signals received from the second AWG.

According to another embodiment of the present invention, there is provided a structure for upstream optical transmission in an integrated wired and wireless wavelength division multiplexing passive optical network (WDM PON) apparatus using a light source mode-locked to fed incoherent light. The integrated wired and wireless WDM PON apparatus comprises: a broadband light source (BLS) for outputting an incoherent optical signal used as fed light; an optical path module for setting paths of the incoherent optical signal input from the BLS and up/downstream optical signals; a first arrayed waveguide (AWG) for demultiplexing the incoherent optical signal input through the optical path module and multiplexing optical modulation signals received from a plurality of wired/wireless optical transmitters.

The plurality of wired optical transmitters, each receive the incoherent optical signal demultiplexed by the first AWG mode-lock the demultiplexed incoherent optical signal for upstream transmission, and optical-modulate the mode-locked incoherent optical signal to carry baseband wired signal data. The plurality of wireless optical transmitters, each receive, and mode-lock and like their wired counterpart, however they optical-modulate the mode-locked incoherent optical signal to carry high frequency radio frequency (RF) signal data.

The integrated wired and wireless WDM PON apparatus in this embodiment further comprises: a second AWG for demultiplexing the multiplexed upstream optical signal received from the first AWG in a wavelength basis; and optical receivers for subscribers and for optical-detecting the demultiplexed upstream optical signals received from the second AWG

### BRIEF DESCRIPTION OF THE DRAWINGS

The above features and advantages of the present invention will become more apparent from the following detailed description when taken in conjunction with the accompanying drawings, in which:

FIG. 1 is a block diagram of a WDM PON using a mode-locked light source according to the prior art;

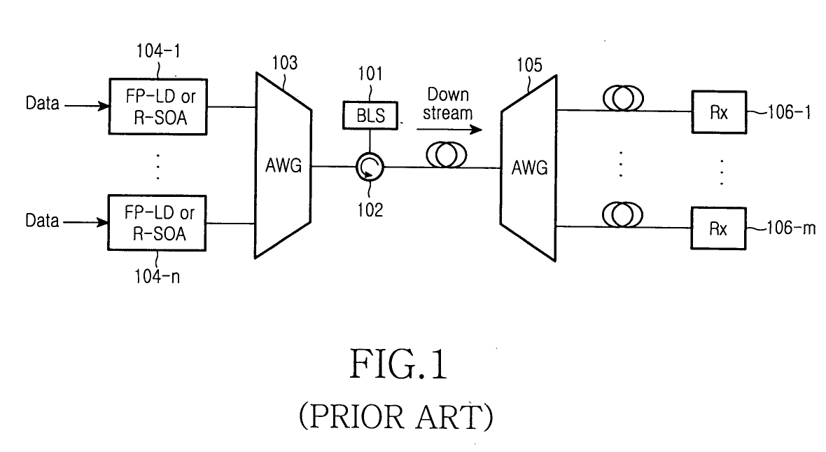

FIG. 2 is a block diagram of an RoF link for transmitting an RF signal according to the prior art;

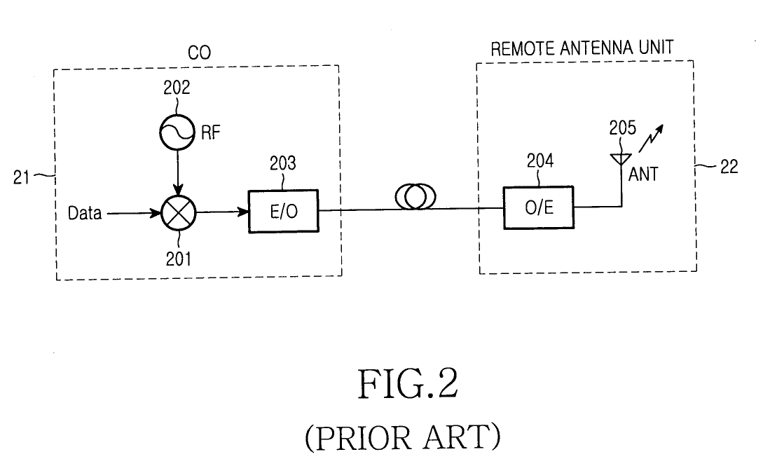

FIG. 3 is a block diagram of a downlink of an integrated wired and wireless WDM PON apparatus for achieving efficient wired and wireless integration, according to a preferred embodiment of the present invention;

FIG. 4 is a block diagram of an uplink of the integrated wired and wireless WDM PON apparatus for achieving efficient wired and wireless integration, according to a preferred embodiment of the present invention; and

FIG. 5 is a block diagram of an optical transmitter used in the integrated wired and wireless WDM PON apparatus for achieving efficient wired and wireless integration, according to a preferred embodiment of the present invention.

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

In the embodiments of the present invention, a Radio-over-Fiber (RoF) link is provided to combine a WDM PON using a mode-locked light source, with a wireless communication network. In the preferred embodiment a fabry-perot electroabsorption modulator laser (FP-EML) is provided as an optical transmitter for the RoF link. That is, the FP-EML is used as an optical transmitter for the RoF link in order to solve the problem associated with narrow modulation bandwidth in E/O conversion of an fabry-perot laser diode (FP-LD) or an Reflective Semiconductor Optical amplifier (R-SOA) used as a conventional mode-locked light source for transmitting a high frequency RF signal in the prior art. The FP-EML is an optical transmitter having a wider modulation bandwidth in E/O conversion than that of the FP-LD or the R-SOA. The RoF link combines the WDM PON which uses a mode-locked light source with the wireless communication network. The combination of the WDM PON using a mode-locked light source and the wireless communication network is done without structure change.

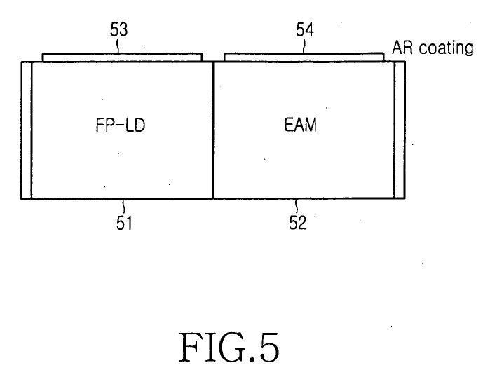

FIG. 5 is a block diagram of an optical transmitter used in an integrated wired and wireless WDM PON apparatus for achieving efficient wired and wireless integration, according to a preferred embodiment of the present invention.

As illustrated in FIG. 5, a FP-EML includes a FP-LD 51 for inputting an optical signal and outputting a mode-locked light source and an electro-absorption modulator (EAM) 52 for optical modulating a high frequency RF signal on the mode-locked light source input from the FP-LD 51.

A high reflection (HR) coating 53 is applied to one edge of the FP-LD 51, and an anti-reflection (AR) coating 54 is applied to one edge of the EAM 52.

Since an FP-LD has a characteristic of generating several “longitudinal modes” in a conventional FP-EML, the conventional FP-EML can be used only for single wavelength systems (e.g., systems using a 1.3 μm wavelength) having a very small dispersion value of standard single mode fiber, not for multi-wavelength systems such as a WDM PON.

However, in the current embodiment, this problem can be solved by using a mode-locked FP-EML. In the mode-locked FP-EML, the FP-LD 51 outputs a single mode optical signal mode-locked by a spectrum split input signal, and the EAM 52 modulates a high frequency RF signal. In this case, since a mode locking method is used, the FP laser's characteristic of generating several “longitudinal modes” is reduced, and thus the mode-locked FP-EML can be used for multi-wavelength systems.

In addition, since the EAM 52 included in the FP-EML optical transmitter has a wide modulation bandwidth, it is advantageous to modulate a high frequency RF signal. Thus, for E/O conversion of the high frequency RF signal, the use of the mode-locked FP-EML is more advantageous than the use of the conventional FP-LD or R-SOA.

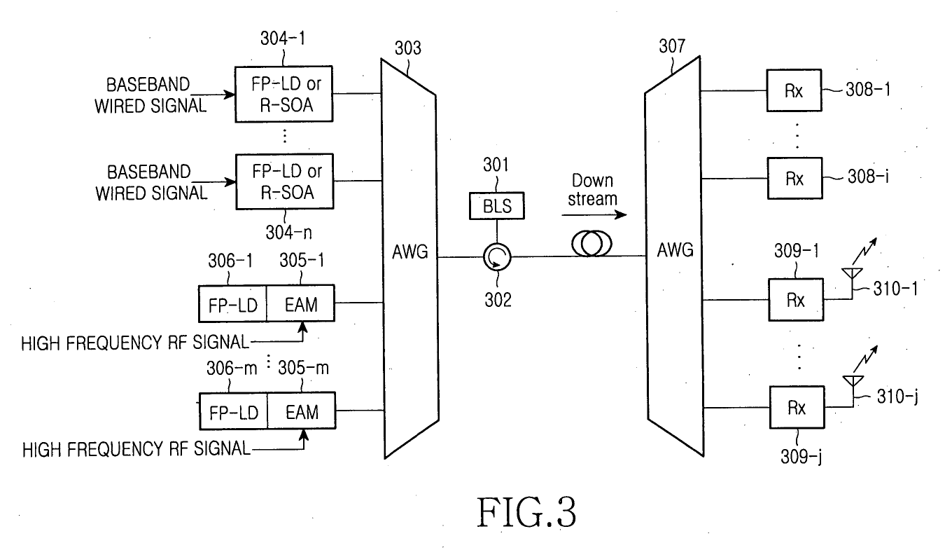

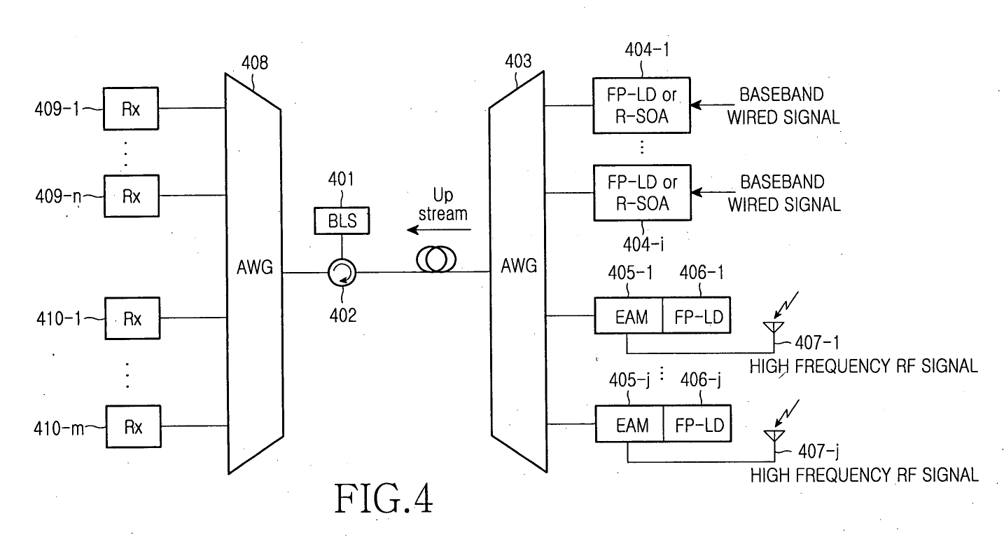

Hereafter the structure and operation of the downlink/uplink of the integrated wired and wireless WDM PON apparatus for achieving efficient wired and wireless integration is described in reference to FIGS. 3 and 4.

FIG. 3 is a block diagram of a downlink of the integrated wired and wireless WDM PON apparatus for achieving efficient wired and wireless integration, according to a preferred embodiment of the present invention.

As illustrated in FIG. 3, the structure of the downlink of the integrated wired and wireless WDM PON apparatus for achieving efficient wired and wireless integration includes a BLS 301 for outputting an incoherent optical signal used as fed light and an optical path module 302 for setting paths of the incoherent optical signal input from the BLS 301 and up/downstream optical signals.

A first AWG 303 is provided for demultiplexing the incoherent optical signal input through the optical path module 302 and multiplexing optical modulation signals received from a plurality of wired/wireless optical transmitters 304-1 to 304-n, 305-1 to 305-m, and 306-1 to 306-m.

The plurality of wired optical transmitters 304-1 to 304-n, are each provided for receiving the demultiplexed incoherent optical signal from the first AWG 303 and optical-modulating the received incoherent optical signal to carry baseband wired signal data for downstream transmission.

The plurality of wireless optical transmitters 305-1 to 305-m and 306-1 to 306-m, are each provided for receiving the demultiplexed incoherent optical signal from the first AWG 303, mode-locking the demultiplexed incoherent optical signal for downstream transmission, and optical-modulating the mode-locked incoherent optical signal to carry high frequency RF signal data.

A second AWG 307 is provided for demultiplexing the multiplexed downstream optical signal received from the first AWG 303 in a wavelength basis, and optical receivers provided for subscribers 308-1 to 308-i and 309-1 to 309-j, each are provided for optical-detecting the demultiplexed downstream optical signal received from the second AWG 307.

In the current embodiment, each of the wired optical transmitters 304-1 to 304-n uses a mode-locked FP-LD or R-SOA. The plurality of wireless optical transmitters 305-1 to 305-m and 306-1 to 306-m include a plurality of FP-LDs 306-1 to 306-m, each for receiving the demultiplexed incoherent optical signal from the first AWG 303 and outputting a mode-locked light source for the downstream transmission, and a plurality of EAM 305-1 to 305-m performing optical modulation to carry high frequency RF signal data on the mode-locked light source of the FP-LDs 306-1 to 306-m.

RoF link modules for receiving and relaying RF signals, which are included in downstream data receivers, include the optical receivers 309-1 to 309-j each for optical-detecting and O/E-converting the demultiplexed downstream optical signal received from the second AWG 307 and antenna modules 310-1 to 310-j for RF-transmitting high frequency RF signals received from the optical receivers 309-1 to 309-j.

Using the above-described structure, an RoF link can be combined with an existing WDM PON by applying separated wired signal optical transmitters for modulating baseband wired signals and separated RF signal optical transmitters for modulating high frequency RF signals to the existing WDM PON.

The operation of the downlink will now be described. The incoherent optical signal output from the BLS 301 is input to an optical transmission end by passing through a circulator, which is the optical path module 302, and being demultiplexed (spectrum-split) by the first AWG 303. The optical transmission end includes the wired optical transmitters 304-1 to 304-n, each using an FP-LD or R-SOA for modulating a baseband wired signal, and the wireless optical transmitters 305-1 to 305-m and 306-1 to 306-m, each using an FP-EML for modulating a high frequency RF signal.

A single downstream optical signal is generated by multiplexing the optical signals modulated by the optical transmission end in the first AWG 303, passes through the circulator 302, and transmitted to a subscriber end.

In the subscriber end, the downstream optical signal is demultiplexed by the second AWG 307 and input to the optical receivers 308-1 to 308-i and 309-1 to 309-j in a wavelength basis. The optical receivers 308-1 to 308-i and 309-1 to 309-j include the wired optical receivers 308-1 to 308-i for receiving wired signals and the wireless optical receivers 309-1 to 309-j for receiving RF signals.

FIG. 4 is a block diagram of an uplink of the integrated wired and wireless WDM PON apparatus for achieving efficient wired and wireless integration, according to a preferred embodiment of the present invention.

As illustrated in FIG. 4, the structure of the uplink of the integrated wired and wireless WDM PON apparatus for achieving efficient wired and wireless integration includes a BLS 401 for outputting an incoherent optical signal used as fed light and a optical path module 402 for setting paths of the incoherent optical signal input from the BLS 401 and up/downstream optical signals.

A first AWG 403 is provided for demultiplexing the incoherent optical signal input through the optical path module 402 and multiplexing optical modulation signals received from a plurality of wired/wireless optical transmitters 404-1 to 404-I, 405-1 to 405-j, and 406-1 to 406-j.

The plurality of wired optical transmitters 404-1 to 404-i, are each provided for receiving the demultiplexed incoherent optical signal received from the first AWG 403, mode-locking the demultiplexed incoherent optical signal, and optical-modulating the mode-locked incoherent optical signal to carry baseband wired signal data for upstream transmission.

The plurality of wireless optical transmitters 405-1 to 405-j and 406-1 to 406-j, are each provided for receiving the demultiplexed incoherent optical signal received from the first AWG 403, mode-locking the demultiplexed incoherent optical signal for upstream transmission, and optical-modulating the mode-locked incoherent optical signal to carry high frequency RF signal data.

A second AWG 408 is provided for demultiplexing the multiplexed upstream optical signal received from the first AWG 403 in a wavelength basis, and optical receivers 409-1 to 409-n and 410-1 to 410-m, each for optical-detecting the demultiplexed upstream optical signal received from the second AWG 408.

In the current embodiment, each of the wired optical transmitters 404-1 to 404-n uses a mode-locked FP-LD or R-SOA. The plurality of wireless optical transmitters 405-1 to 405-j and 406-1 to 406-j include a plurality of FP-LDs 406-1 to 406-j, each for receiving the demultiplexed incoherent optical signal from the first AWG 403 and outputting a mode-locked light source for the upstream transmission, and a plurality of EAM 405-1 to 405-j performing optical modulation to carry high frequency RF signal data input through RF antennas 407-1 to 407-j on the mode-locked light sources of the FP-LDs 406-1 to 406-j.

Using the above-described structure, an RoF link can be combined with an existing WDM PON by applying separated wired signal optical transmitters for modulating baseband wired signals and separated RF signal optical transmitters for modulating high frequency RF signals to the existing WDM PON.

The operation of the uplink will now be described. The incoherent optical signal output from the BLS 401 is input to an optical transmission end by passing through a circulator, which is the optical path module 402, and being demultiplexed (spectrum-split) by the first AWG 403. The optical transmission end includes the wired optical transmitters 404-1 to 404-i, each using an FP-LD or R-SOA for modulating a baseband wired signal, and the wireless optical transmitters 405-1 to 405-j and 406-1 to 406-j, each using an FP-EML for modulating a high frequency RF signal.

A single upstream optical signal is generated by multiplexing the optical signals modulated by the optical transmission end in the first AWG 403, passes through the circulator 402, and transmitted to a central office (CO).

In the CO, the upstream optical signal is demultiplexed by the second AWG 408 and input to the optical receivers 409-1 to 409-n and 410-1 to 410-m in a wavelength basis. The optical receivers 409-1 to 409-n and 410-1 to 410-m include the wired optical receivers 409-1 to 409-n for receiving wired signals and the wireless optical receivers 410-1 to 410-m for receiving RF signals.

As described above, according to the embodiments of the present invention, efficient wired and wireless integration can be achieved by linking a wireless network based on an RoF link to a WDM PON using an FP-EML having a wide modulation bandwidth.

In addition, by using a wired and wireless integration network based on a WDM PON, an RoF link using an FP-EML for high frequency RF signal modulation can be added to an existing WDM PON structure, thereby achieving a wired network-based wireless network subscriber service and a wired and wireless integration operation.

In addition, when a wired and wireless integration network is implemented, a transmission link of an existing WDM PON can be shared without installing additional optical fiber from a CO to a remote node, thereby reducing additional costs for optical fiber installation and network construction.

While the embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A wavelength division multiplexing passive optical network (WDM PON) apparatus using a light source mode-locked to fed incoherent light, the apparatus comprising:
a fed light generator for providing fed light for up/downstream signals using a broadband light source emitting an incoherent optical signal;
a central office (CO) for receiving, mode-locking and downstream-optical-transmitting the incoherent optical signal generated by the fed light generator and for receiving and optical-detecting an upstream optical signal transmitted from a subscriber unit;
the subscriber unit for receiving, mode-locking, and upstream-optical-transmitting the incoherent optical signal generated by the fed light generator and for receiving and optical-detecting a downstream optical signal transmitted from the CO; and
a wired optical transmitter for transmitting a baseband wired signal and a wireless optical transmitter for transmitting a high frequency radio frequency (RF) signal, the wired and wireless optical transmitters are for up/downstream optical transmission of the CO and the subscriber unit.

2. The WDM PON apparatus of claim 1, wherein the wireless optical transmitter comprises:
a Fabry-Perot laser diode (FP-LD) receiving the incoherent optical signal and outputting a mode-locked light source; and
an electro-absorption modulator (EAM) for optical modulating a high frequency RF signal on the mode-locked light source input from the FP-LD.

3. A system for downstream optical transmission in a wavelength division multiplexing passive optical network (WDM PON) apparatus using a light source mode-locked to fed incoherent light, the system comprising:
a broadband light source (BLS) for outputting an incoherent optical signal used as fed light;
an optical path module for setting paths of the incoherent optical signal input from the BLS and up/downstream optical signals;
a first arrayed waveguide (AWG) for demultiplexing the incoherent optical signal input through the optical path module and transmitting the demultiplexed incoherent optical signals to a plurality of wired/wireless optical transmitters, and multiplexing optical modulation signals received from the plurality of wired/wireless optical transmitters;
the plurality of wired optical transmitters, each for receiving the demultiplexed incoherent optical signal from the first AWG, mode-locking the demultiplexed incoherent optical signal for downstream transmission, and optical-modulating the mode-locked incoherent optical signal to carry baseband wired signal data;
the plurality of wireless optical transmitters, each for receiving the demultiplexed incoherent optical signal from the first AWG, mode-locking the demultiplexed incoherent optical signal for downstream transmission, and optical-modulating the mode-locked incoherent optical signal to carry high frequency radio frequency (RF) signal data;
a second AWG for demultiplexing the multiplexed downstream optical signal received from the first AWG in a wavelength basis; and
optical receivers for subscribers for optical-detecting the demultiplexed downstream optical signals received from the second AWG.

4. The system of claim 3, wherein each of the plurality of wireless optical transmitters comprises:
an FP-LD for receiving the demultiplexed incoherent optical signal from the first AWG and outputting a mode-locked light source for the downstream transmission; and
an EAM for performing optical modulation to carry high frequency RF signal data on the mode-locked light source of the FP-LD.

5. The system of claim 4, wherein a high reflection (HR) coating is applied to the FP-LD, and an anti-reflection (AR) coating is applied to the EAM.

6. The system of claim 3, wherein each of the plurality of wired optical transmitters comprises an FP-LD.

7. The system of claim 3, wherein each of the plurality of wired optical transmitters comprises a reflective semiconductor optical amplifier (R-SOA).

8. A system for upstream optical transmission in a wavelength division multiplexing passive optical network (WDM PON) apparatus using a light source mode-locked to fed incoherent light, the system comprising:
a broadband light source (BLS) for outputting an incoherent optical signal used as fed light;
an optical path module for setting paths of the incoherent optical signal input from the BLS and up/downstream optical signals;
a first arrayed waveguide (AWG) for demultiplexing the incoherent optical signal input through the optical path module and multiplexing optical modulation signals received from a plurality of wired/wireless optical transmitters;
the plurality of wired optical transmitters, each for receiving the incoherent optical signal demultiplexed by the first AWG; mode-locking the demultiplexed incoherent optical signal for upstream transmission, and optical-modulating the mode-locked incoherent optical signal to carry baseband wired signal data;
the plurality of wireless optical transmitters, each for receiving the demultiplexed incoherent optical signal from the first AWG, mode-locking the demultiplexed incoherent optical signal for upstream transmission, and optical-modulating the mode-locked incoherent optical signal to carry high frequency radio frequency (RF) signal data;
a second AWG for demultiplexing the multiplexed upstream optical signal received from the first AWG in a wavelength basis; and
optical receivers for subscribers for optical-detecting the demultiplexed upstream optical signals received from the second AWG

9. The system of claim 8, wherein each of the plurality of wireless optical transmitters comprises an FP electro-absorption modulated laser (FP-EML) comprising:
an FP-LD for receiving the demultiplexed incoherent optical signal from the first AWG and outputting a mode-locked light source for the upstream transmission; and
an EAM for performing optical modulation to carry high frequency RF signal data for the upstream transmission on the mode-locked light source of the FP-LD.

10. The system of claim 9, wherein a high reflection (HR) coating is applied to the FP-LD, and an anti-reflection (AR) coating is applied to the EAM.

11. The system of claim 8, wherein each of the plurality of wired optical transmitters comprises an FP-LD.

12. The system of claim 8, wherein each of the plurality of wired optical transmitters comprises a reflective semiconductor optical amplifier (R-SOA).
